(19) United States
(12) Patent Application Publication
(10) Pub. No.: US 2011/0298752 A1
(43) Pub. Date: Dec. 8, 2011

(54) ELECTRONIC DEVICE WITH INFRARED TOUCH INPUT FUNCTION

(75) Inventors: KUAN-HONG HSIEH, Tu-Cheng (TW); XIN ZHAO, Shenzhen City (CN); KUN-CHIH HSIEH, Tu-Cheng (TW); WEN-HSING LIN, Tu-Cheng (TW); BO PENG, Shenzhen City (CN); MING LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/972,502

(22) Filed: Dec. 19, 2010

(30) Foreign Application Priority Data
Jun. 2, 2010 (CN) 201010189947.3

(51) Int. Cl. G06F 3/042

(52) U.S. Cl. 345/175

(57) ABSTRACT

An electronic device includes a display panel and an infrared touch module. The infrared touch module includes a circuit board mounted parallelly under the display panel. An array of infrared emitters and receivers arranged along one side of each pair of adjacent sides of the circuit board, and facing a corresponding one of the array of light emitters on the opposite side. A light guide is mounted on each infrared emitter and each infrared receiver, and the light guide one each infrared emitter is operable to guide the light emitted from the light emitter to the corresponding infrared receiver via the light guide mounted thereon.

### BACKGROUND

1. Technical Field

The present disclosure relates to electronic devices, and particularly, to an electronic device with infrared touch input function.

2. Description of the Related Art

An infrared input system often includes a circuit board having a first pair of opposite sides positioned parallel to a first axis and a second pair of opposite sides positioned parallel to a second axis perpendicular to the first axis. The four sides corporately define a generally rectangular touch input area. A linear array of light emitting devices is arranged along each side. A light detection device is positioned at each corner of the circuit board. A controller is coupled to the light emitting devices and the light detection devices. The controller sequentially activates each linear array and activates the light detection devices positioned at the corners of the circuit board opposed to the activated array of light emitting devices. One problem with device using such an infrared input system is that the device is usually thicker than people otherwise expect.

Therefore, a thinner electronic device with infrared touch input function, which overcomes the problems is desired.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric, exploded view of an electronic device with infrared touch input function in accordance with an exemplary embodiment.

FIG. 2 is an enlarged, isometric view of a light guide of the electronic device in FIG. 1.

FIG. 3 is a cross-sectional view taken along line of FIG. 2.

FIG. 4 is a cross-sectional view showing an infrared emitter and a coupling receiver of the electronic device in FIG. 1.

### DETAILED DESCRIPTION

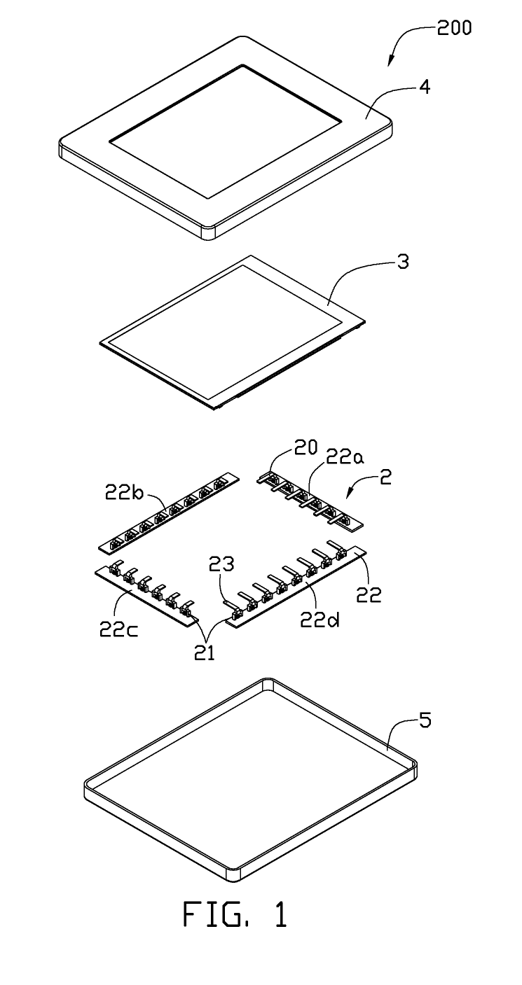

Referring to FIG. 1, an electronic device 200 with infrared touch input function includes an infrared touch module 2, a display panel 3, a front cover 4, and a rear cover 5. The display panel 3 may be a flat panel display defining an information display area. The infrared touch module 2 is mounted between the display panel 3 and the front cover 4. The infrared touch module 2 includes a linear array of infrared emitters 20, a linear array of infrared receivers 21, and a rectangular circuit board 22. In this embodiment, the circuit board 22 is divided into two pairs of oppositely disposed circuit boards 22a, 22b, 22c, and 22d, corporately defining an open area corresponding in size and shape corresponding to the information display area. The circuit boards 22a, 22b, 22c, 22d are arranged around the periphery of the display panel 3. The light emitters 20 are arranged along one side of each pair of adjacent circuit boards 22a, 22b, and the light receivers 21 are arranged along the other one side of each pair of adjacent circuit boards 22c, 22d, and face the light emitters 20. The light receivers 21 respectively receive infrared light from the array of light emitters 20. In an exemplary embodiment, the light emitters 20 are light emitting diodes that emit infrared light, and the light receivers 21 are light phototransistors. The liner array of infrared emitters 20 and receivers 21 are vertically mounted on the circuit boards 22a, 22b, 22c, 22d.

The infrared touch module 2 further includes a plurality of light guides 23, each light guide is mounted on each infrared emitter 20 and each infrared receiver 21, and the light guide 23 on each infrared emitter 20 is operable to guide the light emitted from the infrared emitter 20 to the corresponding infrared receiver 21 via the light guide 23 mounted thereon. Each light guide 23 is transparent.

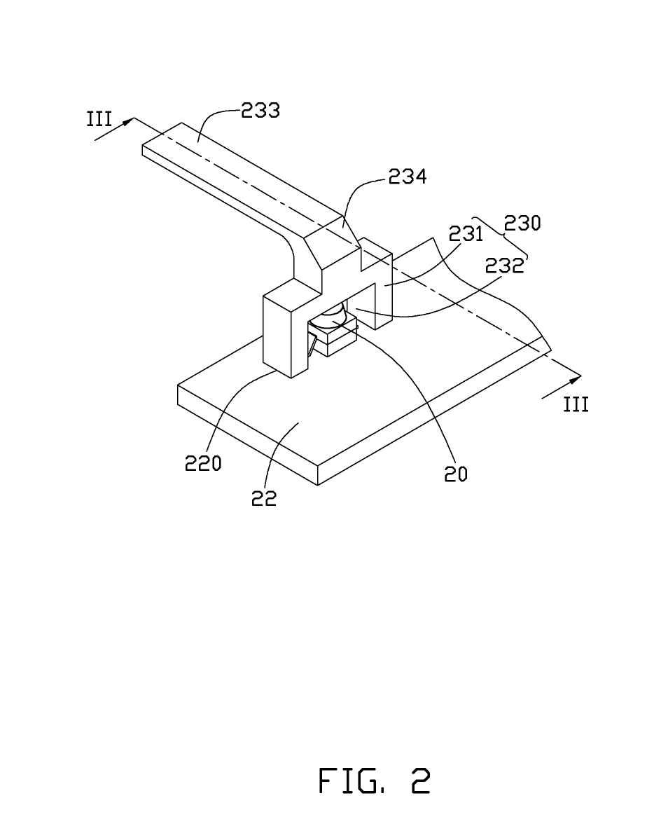

Referring to FIG. 2, an isometric view of a light guide of the electronic device is illustrated. The light guide 23 includes a base 230 and a guiding portion 233 extending outwardly from the base 230. The bases 230 are vertically mounted on the circuit boards 22a, 22b, 22c, 22d and each respectively correspond to one of the infrared emitters 20 or one of the infrared receivers 21. In an exemplary embodiment, each of the bases 230 includes a pair of supporting legs 231, a space 232 is defined between the two supporting legs 231. The space 232 is used to receive one of the infrared emitters 20 or one of the infrared receivers 21. A plurality of fixing holes 220 are formed in the circuit boards 22, corresponding to the supporting legs 231. Ends of the two supporting legs 231 are fitted into the fixing holes 220, which fix the base 230 on the circuit boards 22a, 22b, 22c, 22d.

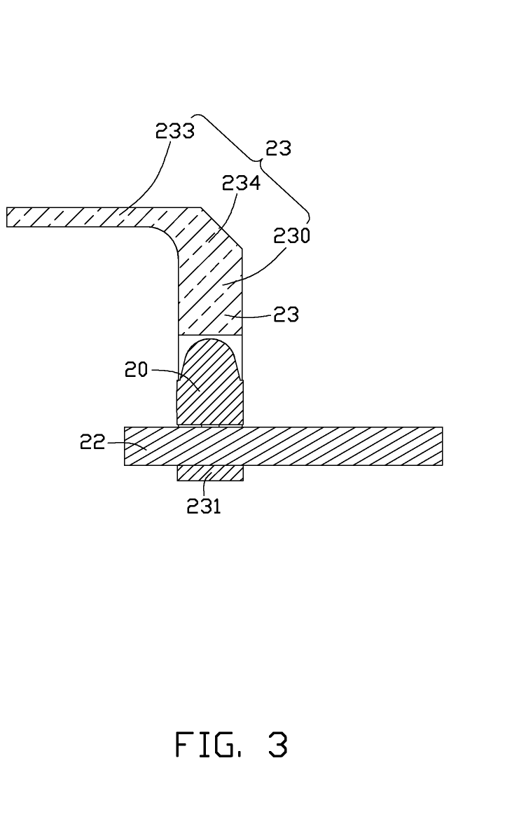

Referring also to FIG. 3, the guiding portion 233 of each light guide 23 locates above the corresponding infrared emitter 20 or the corresponding infrared receiver 21. The free end of a guiding portion 233 located above an infrared emitter 20 faces a free end of a guiding portion 233 located above a corresponding infrared receiver 21. The guiding portion 233 located above an infrared emitter 20 guides light beams from the infrared emitter 20 to the corresponding infrared receiver 21. The guiding portion 233 located above an infrared receiver 21 is used to guide light beams received from the corresponding infrared emitter 20 to the infrared receiver 21. Each guiding portion 233 includes a reflective surface 234 used to reflect light from an infrared emitter 20 to a corresponding infrared receiver 21. In an exemplary embodiment, the angle between the reflective surface 234 and the display panel 3 is about 45 degrees.

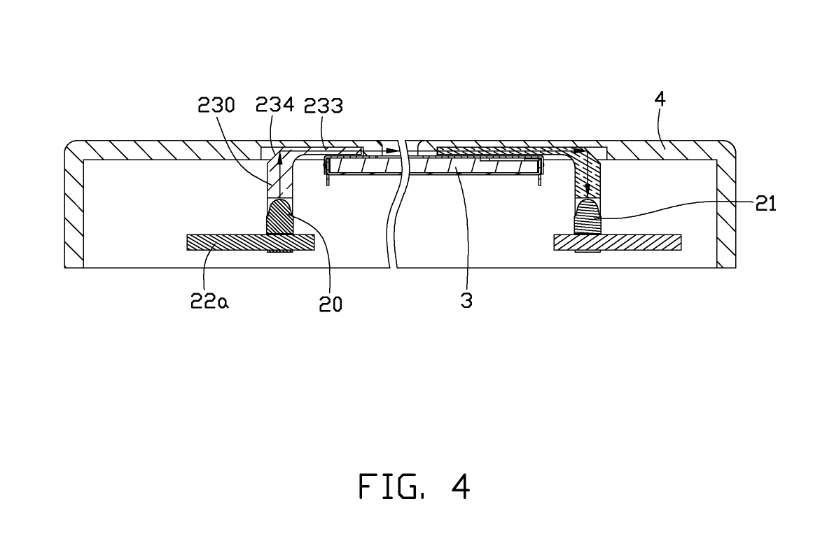

Referring to FIG. 4, during operation, the light beam from an infrared emitter 20 firstly projects into a light guide 23 located above the infrared emitter 20, and then is reflected by the reflective surface 234 of the light guide 23. The light beam is further transmitted into another light guide 23 located above a coupling infrared receiver 21, and further reflected by the reflective surface 234 of the another light guide 23 to the coupling infrared receiver 21. However, if an object touches the information display area and blocks the light beam, the infrared receiver 21 will not receive the light beam, the infrared receiver 21 feeds back signals to a controller (not shown) and the controller determines the position of the object according to the signal fed back by the infrared receiver 21. Therefore, the infrared emitters 20 and infrared receivers 21 vertically mounted on the circuit board 22 enables an infrared touch function. The thickness between the light guides 23 and the circuit boards 22 can be made thin to realize a very thin electronic device.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device comprising:
a display panel;
an infrared touch module comprising:
a rectangular circuit board parallelly mounted under the display panel;
an array of infrared emitters arranged along one side of each pair of opposite sides of the circuit board;
an array of infrared receivers arranged along the other one side of each pair of adjacent sides of the circuit board, and facing a corresponding one of the array of light emitters on the opposite side, the infrared receivers being configured for receiving infrared light from the array of light emitters correspondingly; and
wherein a light guide is mounted on each infrared emitter and each infrared receiver, and the light guide one each infrared emitter is operable to guide the light emitted from the light emitter to the corresponding infrared receiver via the light guide mounted thereon.

2. The electronic device as recited in claim 1, wherein the light emitters are light emitting diodes that emit infrared light beam, and the light receivers are light phototransistors.

3. The electronic device as recited in claim 1, wherein the arrays of infrared emitters and receivers are vertically mounted on the circuit board.

4. The electronic device as recited in claim 1, wherein the light guides are transparent.

5. The electronic device as recited in claim 1, wherein the display panel includes an information display area, the circuit board is divided into two pairs of oppositely disposed circuit boards arranged around the periphery of the display panel, corporately defining an open area corresponding in size and shape corresponding to the information display area.

6. The electronic device as recited in claim 5, wherein the light emitters are arranged along one side of each of a first pair of the adjacent circuit boards, and the light receivers are arranged along one side of each of a second pair of the adjacent circuit boards.

7. The electronic device as recited in claim 1, wherein each of the light guides comprises:
a base vertically mounted on the circuit board respectively corresponding to one of the infrared emitters or one of the infrared receivers; and
a guiding portion extending outwardly from the base, and located above an infrared receiver to guide light beams received from the corresponding infrared emitter to the infrared receiver.

8. The electronic device as recited in claim 7, wherein a free end of the guiding portion located above an infrared emitter faces a free end of the guiding portion located above a corresponding infrared receiver.

9. The electronic device as recited in claim 7, wherein the guiding portion comprises a reflective surface used to reflect light from the infrared emitter or an infrared emitter corresponding to the infrared receiver.

10. The electronic device as recited in claim 9, wherein an angle between the reflective surface and the display panel is about 45 degrees.

11. The electronic device as recited in claim 7, wherein the base comprises:
a pair of supporting legs, a space is defined between the pair of supporting legs, and configured for receiving the infrared emitter or the infrared receiver;

12. The electronic device as recited in claim 11, wherein a plurality of fixing holes are formed in the circuit board, corresponding to the supporting legs; ends of the supporting legs are fitted into the fixing holes, which fix the base on the circuit boards.
